(19) United States
(12) Patent Application Publication
(10) Pub. No.: US 2008/0148235 A1
(43) Pub. Date: Jun. 19, 2008

(54) Runtime inspection of user interfaces

(75) Inventors: Adalberto Foresti, Bellevue, WA (US); Guosheng Deng, Kirkland, WA (US); Stanimir Kirilov, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/639,768

(22) Filed: Dec. 15, 2006

(51) Int. Cl. G06F 9/44; G06F 3/14

(52) U.S. Cl. 717/123; 717/126; 717/125

(57) ABSTRACT

Runtime inspection of user interfaces a software application is provided. After a given software application launches, a user interface inspection system records any hierarchy of or relationship between user interface components, and records attributes of various UI components contained in an inspected user interface, for example, placement location of individual controls, spacing between individual controls, sizes of controls, coloring for controls, and the like. The user interface inspection system analyzes the attributes of the displayable controls of a runtime user interface against design guidelines developed for the inspected user interface components and produces reports including information about any deviations between the displayable user interface components and the UI design guidelines. An automation may be run against the software application user interface before or simultaneous with the user interface inspection to determine whether any potential user interface components will not be or are not covered by a given user interface inspection. The results of the automation may be used to ensure that a maximum number of potential user interface components are inspected.

### BACKGROUND

During software application development, design guidelines are usually created for software application user interfaces that ensure the quality and the usability of the user interfaces. Design guidelines ensure that user interface components are properly associated with underlying functionality and ensure the visual quality and consistency of user interface components. For example, design guidelines for a given user interface ensure that if a given button is actuated, the corresponding software functionality is executed, and the guidelines ensure that the button is visually appropriate in terms of such physical attributes as placement location, size, distance from other user interface components, display color, and the like. The enforcement of design guidelines for user interfaces is typically accomplished through manual inspection during the design and development phase of the user interfaces. Unfortunately, manual verification of compliance with user interface design guidelines during the development of a user interface often does not catch user interface defects (bugs) that appear during application runtime. Moreover, verification of compliance with design guidelines during user interface development typically does not allow for inspection of all user interface components of a given software application, but instead only involves manual inspection of a sampling of user interface components.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing runtime inspection of user interfaces and components of user interfaces of a given software application. User interface inspection of the present invention allows user interface (UI) developers to verify whether a certain user interface design meets design guidelines developed for the user interface in a runtime environment. In addition, user interface inspection also provides a way to predict the percentage of UI components that are or are not encountered during the inspection.

According to embodiments, after a given software application launches and shows a targeted user interface either by manual navigation or automation, a user interface inspection system scans through the targeted user interface components of the application. The user interface (UI) inspection system records any hierarchy of or relationship between user interface components, and the UI inspection system records attributes of various UI components contained in an inspected user interface, for example, placement location of individual controls, spacing between individual controls, sizes of controls, coloring for controls, and any other control properties given that a corresponding application plug-in is present and is run.

The user interface inspection system analyzes the attributes of the displayable controls of a runtime user interface against the design guidelines developed for the inspected user interface components and produces reports including information about any deviations between the displayable user interface components and the UI design guidelines. The design guidelines are configured as rules in the UI inspection system and are configurable to serve different purposes. For example, different user interface components or different collections of user interface components may have different sets of configured design rules. In addition, user defined design guidelines may be added to a set of software application developer design guidelines if desired. Using a basic set of design guidelines, users may build increasingly complex guideline sets by combining individual guidelines and associated configured rules.

When violations of design rules and associated guidelines are found via the user interface inspection system, the user interface inspection system may explain the violations by displaying the violations in a report, and a user or UI developer then has a choice of addressing the defect or modifying the design guideline or rule to represent an acceptable exception. The reports produced by the UI inspection system also may include warnings that may be displayed in association with UI component defects (bugs) and suggestions for repairing defects.

According to other embodiments, an automated testing method may be run against a software application user interface to determine whether any potential user interface components will not be or are not covered by a given user interface inspection. The results of the automated testing method are compared to the results of the user interface inspection and may be used to ensure that a maximum number of potential user interface components are inspected.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a simplified block diagram and flow chart illustrating the operation of components of a user interface inspection system and method.

FIG. 2A illustrates a system architecture and operation of a design rule processor that processes user interface design rules interpreted from design guidelines.

FIG. 2B is a simplified block diagram illustrating a relationship between components of a design rule and an analyzed user interface.

FIG. 3 is a simplified block diagram illustrating a relationship between design guidelines of a software application user interface and the actual construction and execution sequence of a rule set that represents the design guidelines

FIG. 4 is an example screenshot of a user interface inspection report viewer.

FIG. 5 is an example screenshot of a user interface inspection report viewer.

FIG. 6A is a logical flow diagram illustrating a method of inspecting a software application user interface.

FIG. 6B is a simplified block diagram illustrating how a user interface snapshot instance is checked against a design rule.

FIG. 7 is a logical flow diagram illustrating a method for automatically determining a number of user interface snapshots that are engaged during a snapshot engagement automation.

FIGS. 8, 9 and 10 illustrate computer screen displays of example user interface components for which a user interface coverage system may be used for ensuring inspection of available user interface components.

FIG. 11 illustrates an exemplary computing operating environment in which embodiments of the present invention may be practiced.

### DETAILED DESCRIPTION

As briefly described above, embodiments of the present invention are directed to runtime inspection of user interfaces and components of user interfaces of a given software application. A user interface (UI) inspection system includes a configurable framework for runtime verification of a software application user interface and associated user interface components against an arbitrary set of design guidelines. The guidelines are configured into rules that may be described in a standard format, for example, in a form of code that may be uploaded dynamically, such as an Extensible Markup Language (XML) file. The guidelines may be programmed to be run separately or to be combined together and applied either in sequence or in parallel to create arbitrarily more complex rules. For example, one rule may stipulate that a user interface button must be at least ten pixels away from a user interface border, and a second rule may stipulate that a user interface border must be a certain width. Such rules may be applied separately to the components of a given user interface, or such rules may be combined and then applied to the components of the user interface.

At software application runtime, the user interface of a given software application is traversed automatically by the user interface inspection system or through interaction with the user interface inspection system. A user interface “snapshot” is generated for each permutation of the combinations of user interface components that may be displayed in the software application user interface. The snapshot can be stored as a file in a certain format such as XML. During application runtime, the user interface inspection system explores and captures the control properties for the user interface and stores them into snapshot files. A dedicated rule processor subsequently analyzes the attributes of UI controls defined in each UI snapshot file against the design guidelines developed for the inspected user interface components (plus any user-defined design guidelines) and produces reports including information about any deviations between the displayable user interface components and the UI design guidelines. In addition, a score is determined for each snapshot based on its compliance with the guidelines applied by the user interface inspection system. The violations and scoring results for each UI snapshot are stored in a database for subsequent processing.

Subsequent processing of stored scoring information may include comparison of different user interface resolution settings of a given software application; comparison of the same user interface in different versions of a given software application; and comparison of the user interface of different software applications that follow the same design guidelines, for example, for industry certification. In addition, the results of runtime user interface inspection may be utilized by user interface developers for detecting defects (bugs) found in a user interface, for example, where one user interface component overlaps another user interface component when displayed during runtime.

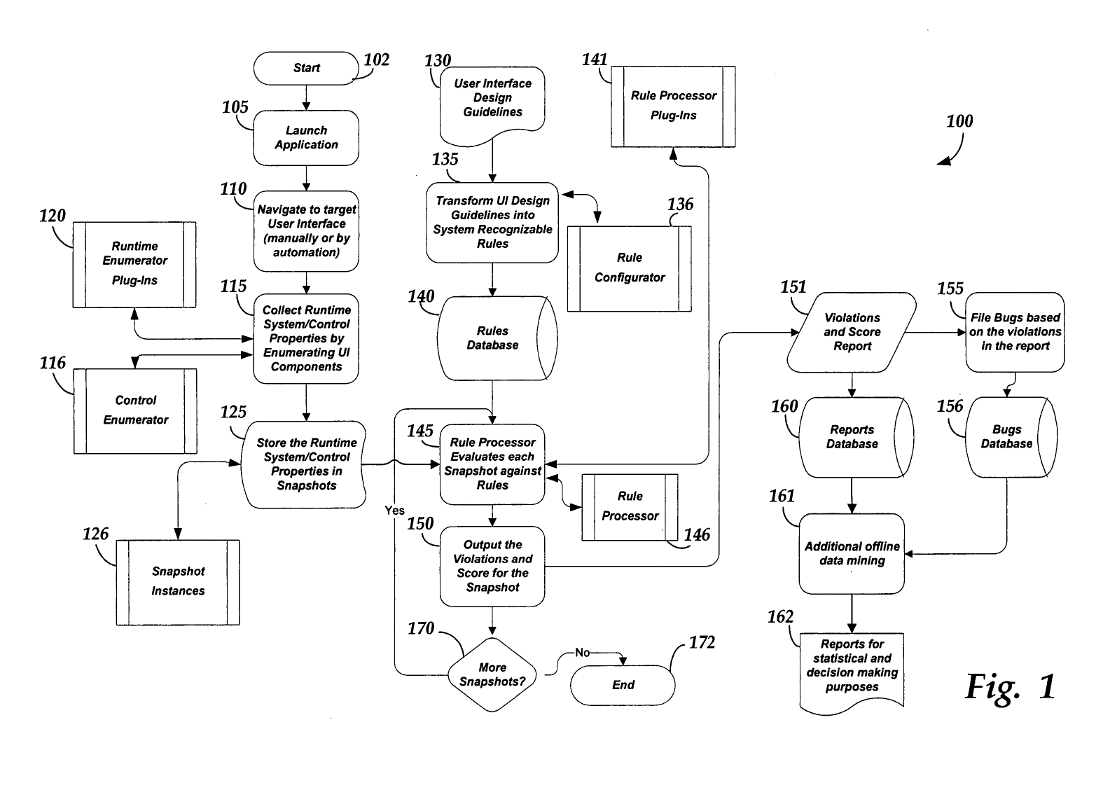

FIG. 1 is a simplified block diagram and flow chart illustrating the operation of components of a user interface inspection system and method for runtime inspection of one or more targeted user interface components or combinations of user interface components of a given software application. The operation 105 is illustrative of the launching of a software application product, for example, a word processing application, a spreadsheet application, a slide presentation application, or any software application having user interfaces made up of one or more user interface components for allowing a user to interact with the functionality of a given software application. The operation 110 is illustrative of the navigation to a display of various user interface components during runtime of a given software application. For example, the operation 110 could include navigation to and display of one or more user interface functionality controls comprising a word processing application user interface. For another example, the operation 110 could include navigation to and display of an electronic mail message entry or display area and associated electronic mail functionality buttons or controls of an electronic mail user interface. Thus, the operation 110 is illustrative of the navigation to and display of one or more user interface screens or displays provided by a given software application 105 as those user interface components occur when the software application is running.

Referring still to FIG. 1, a control enumeration operation 115 may be enabled by a Control Enumerator component 116 operative to create snapshot of user interface components or combinations of components and for loading information about the components including hierarchies of and relationships between individual user interface components into a standard format that may be uploaded and utilized by the user interface inspection system 100 for inspecting a given user interface component or combination of user interface components. According to one embodiment, the standard format includes a form of code that may be uploaded dynamically by the user interface inspection system 100, for example an Extensible Markup Language (XML) file.

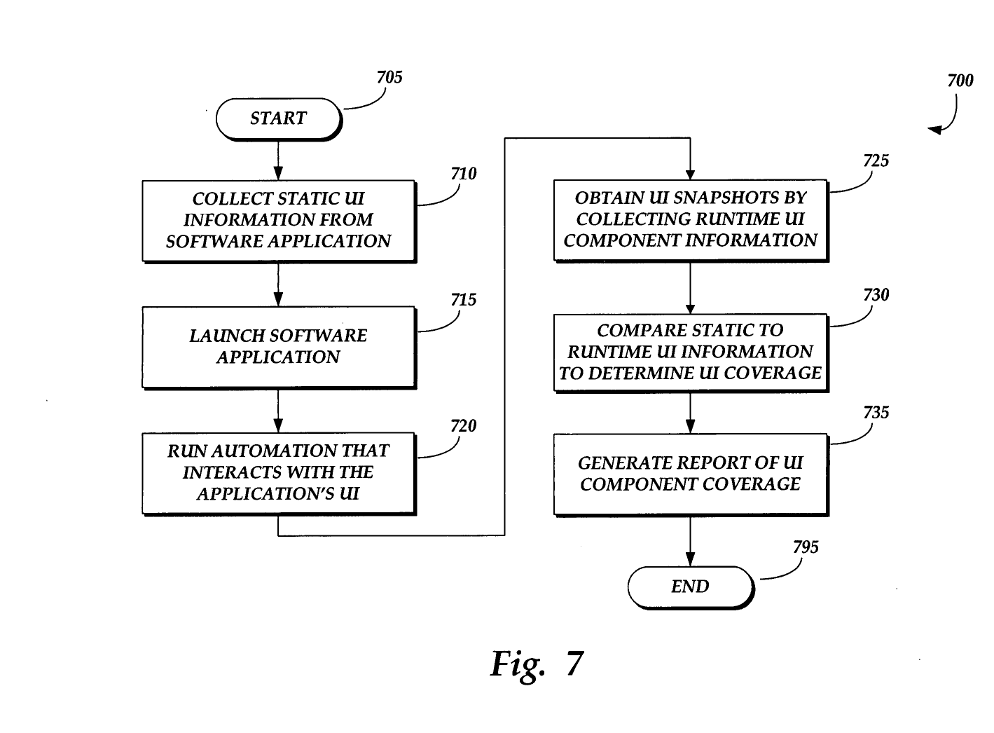

The plug-ins component 120 is illustrative of one or more runtime plug-ins that the Control Enumerator 116 may load to obtain control properties while enumerating a control hierarchy representing a runtime structure for a targeted user interface runtime. For example, a plug-in operation could include the positioning of a control or doing more extensive analysis like checking for truncations. Runtime resource collecting is also done by plug-in 120 which may be used subsequently to compute the user interface coverage, described below with respect to FIG. 7. According to an embodiment, these plug-ins are run in a test environment in runtime and collect necessary runtime information the Rule Processor 146, described below, may need to analyze a user interface when the plug-ins are run.

A snapshot operation 125 is illustrative the generation of one or more “snapshot” instances 126 of user interface components or combinations of user interface components for analyzing against the design guidelines or rules described herein. According to embodiments of the present invention, at software application runtime, one or more user interface snapshots are generated for analyzing against the design guidelines or rules developed for the launched software application. A given UI snapshot file includes data representing the components (e.g., buttons, data entry/editing area, etc.) of a user interface, data representing a display configuration of the components of the user interface (e.g., position, size, etc.) for the components of the user interface and other concurrent system state information (e.g. system environment variables, system resource status, etc.). For example, a given software application, such as a word processing application, may have a main user interface comprising a text entry and editing area and comprising one or more buttons or controls situated along an edge of the text entry and editing area for applying functionality of the word processing application to text or data entered into the text entry and editing area. A snapshot file for the main word processing user interface, for example, includes data on each component of the user interface, for example, an enumeration of each button or control contained in the user interface, a size, placement location, shape and other physical attribute data for each button or control, and the like. If a given control is located or displayed in a manner which will ultimately be found as defective, the control may be flagged by the user interface inspection system 100 in response to a rule analysis against the control based on the information provided in the snapshot file, for example, where a user interface button overlaps another user interface button.

According to embodiments, a different snapshot instance is generated by the control Enumeration operation 115 for each permutation of combinations of user interface components that may be displayed by the software application 105. For example, a different snapshot instance for a given user interface may include all buttons or other user interface components of the main user interface when a dropdown menu is deployed in the main user interface. Another example snapshot file of the same user interface may include the combination of controls displayed in the user interface after a given control is selected. As will be described below, it is advantageous to analyze the maximum potential user interface snapshot instances during runtime of the software application so that any potential user interface defects or bugs may be discovered and reported. According to an embodiment of the present invention, the snapshot instances 126 for user interfaces of a given software application can be stored as files in certain format such as XML. The snapshots may be readily uploaded to the user interface inspection system 100 and that may be analyzed against similarly formatted design guidelines or rules, as described below.

Referring still to FIG. 1, the Design Guidelines component 130 of the user interface inspection system 100 includes a set of arbitrary design guidelines developed for a given user interface for a given software application. For example, a set of design guidelines 130 may be developed for the user interface of a spreadsheet application, and the design guidelines may dictate the placement and size of functionality buttons and/or controls contained in a toolbar of functionality buttons or controls displayed by the example spreadsheet application. The guidelines may dictate how much space is available in a given button or control for containing a text label. The guidelines may dictate the shapes and sizes of borders around buttons or controls. The guidelines may dictate the shapes, sizes, and placements of dropdown menus associated with functionality buttons and/or controls, and the like. As should be appreciated, a different set of design guidelines may be developed for any number of software application user interfaces, or alternatively, a single set of design guidelines may be developed for user interfaces of different software applications comprising a family or suite of applications to ensure a consistent look and feel of user interface components across the family or suite of software applications.

A rule configuration operation 135 is enabled by a Rule Configurator module 136 which is operative to create, modify, load, append, and/or save a set of rules 140 in a format that may be used by the user interface inspection system 100 for analyzing user interface snapshots 126 for compliance with the design guidelines. The rule configuration 135 enables the configuration and saving of a set of rules for use by the Rule Processor 146 for analysis of each snapshot file (instance) 126. According to one embodiment, the set of rules may be formatted in an XML format that may be used by the user interface inspection system 100 against an associated XML-formatted user interface snapshot file 125.

The Rules Database component 140 contains the rules created and exported by the Rule Configurator module 136 during operation 135 for use by the UI inspection system 100 in analyzing the UI snapshots 125. When configuring rules, a given rule may have different base weights depending on the importance of the rule in a given UI component combination and depending on an importance of each rule to a desired user interface display attribute. According to an embodiment, a weighting may be set for each rule on a scale of 0.0 to 10.0. For example, a rule that filters out invisible controls can be given zero (0.0) as a weighting, unless the number of invisible controls is an important factor of the ultimate quality (score) of an associated UI. According to an embodiment, the default base weight for each rule is 5.0 out of 10.0, but the default score may be changed as required. If no rules are present for a given user interface snapshot, then the user interface snapshot may receive an automatic perfect score (e.g., 10.0) because there is no basis for failing to verify the compliance of the snapshot file against the design guidelines for the user interface. On the other hand, if a set of rules has been configured from a set of design guidelines for a given user interface snapshot, then the user interface snapshot file is analyzed by the user interface inspection system 100 against the rules, and a score is given based on how the snapshot file compares against the rules. For an example operation of an applied rule, a rule that requires a sufficient amount of space to be included in a user interface button to allow the inclusion of a text-based label may be given one weight, while the thickness of a shadow border around the button for providing a certain visual effect may be given a lesser weight. Thus, if such a user interface button is analyzed according to these weighted rules, then if the button does contain sufficient space for including a text-based label, but does not have a required thickness of an included shadow border, then this particular example user interface component will receive a higher score than a similar button that does not have sufficient space for a text-based label, but that includes a shadow border having a proper thickness.

The rule processing operation 145 is enabled by a Rule Processor component or module 146 operative for performing analysis and evaluation of user interface components against configured design rules for verifying compliance of UI components and combinations of UI components against the rules. For example, the Rule Processor component 146 may be operative for performing computation of internal display space in a given UI to determine whether enough space is available for containing UI controls that are to be displayed in the UI. For another example, the Rule Processor component 146 may be operative for determining and computing truncation data which is a determination as to whether text for a given control is not visible due to insufficient space for containing and displaying the text in the user interface control. As should be appreciated, the Rule Processor may be operative to analyze given UI components against a number of other types of design guidelines/rules. Evaluating a user interface snapshot file includes identifying any user interface components of the user interface snapshot file that violate any of the one or more design rules and determining a number of violations of any of the user interface design rules occurring in the user interface snapshot file. The scoring generated by the Rule Processor component 146 is based on the rules and rules weightings, described above. According to an embodiment, the rule weightings for a given UI are summed up and a comprehensive weighting is computed for each rule by dividing the individual weight for each rule by the sum. A raw score for each rule is computed based on the number rule outputs for a given UI. The higher the number, the lower the raw score. According to an embodiment, the raw scores range from 0.00 to 10.00. All raw scores are next multiplied by the comprehensive weighting to compute a comprehensive score. The total score of a given UI is then computed by summing up all comprehensive scores.

Referring still to FIG. 1, the Rule Processor Plug-ins component 141 of the user interface inspection system 100 is operative to supply with the Rule Processor 146 with actual assemblies that may be configured in the rules 142 to achieve different rule analyses. For example, one plug-in may be checking UI component overlapping. If the rules 142 contain this rule analysis, the Rule Processor 146 may call the overlapping plug-in when it is evaluating this rule. The plug-ins have common interfaces that may be recognized and configured through the Rule Processor 146. New plug-ins may be created and added to the plug-ins 141 to meet new UI analysis needs. Only the plug-ins that are described in the rules 142 are loaded by the Rule Processor 146.

In addition to generating a score for a given user interface snapshot, the Rule Processor 146 is responsible for generating a report 151 for allowing a user or developer to see a score and any problems associated with a given user interface snapshot and for receiving other information about the associated user interface snapshot, as described below. Reports generated by Rule Processor 146 are described in further detail below. In addition, the Rule Processor 146 is responsible for exporting the report during operation 150 to the report 151. The report 151 contains any violations against the associated rule set along with runtime system/snapshot information and UI score data (described above). Based on the report, a defects (bugs) operation 155 enables the filing (manually or automatically) of UI defects from the report 151. The defects may be stored in a dedicated database 156, and the report 151 may be stored in a reports database 160 from which the data may be extracted for review and further analysis during additional analysis operation 161. For example, the rules violations statistics may be obtained from the both databases 156, 160 for support of a decision-making operation 162, where decisions regarding revisions to the analyzed user interface may be made.

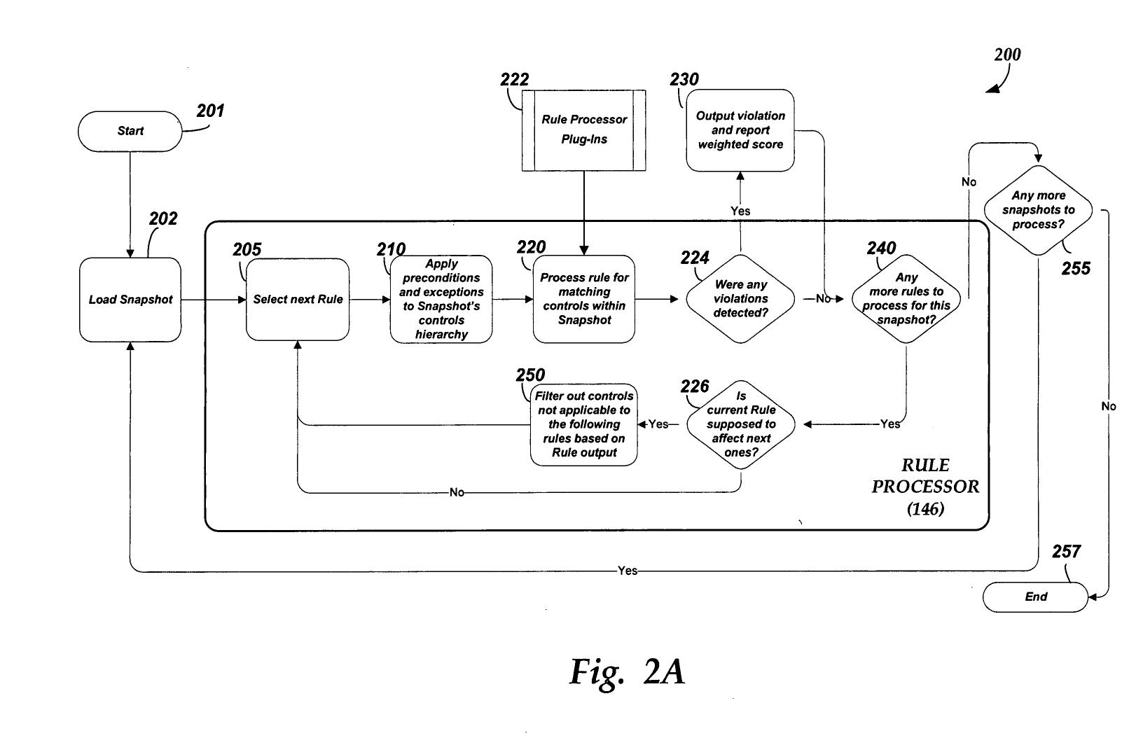

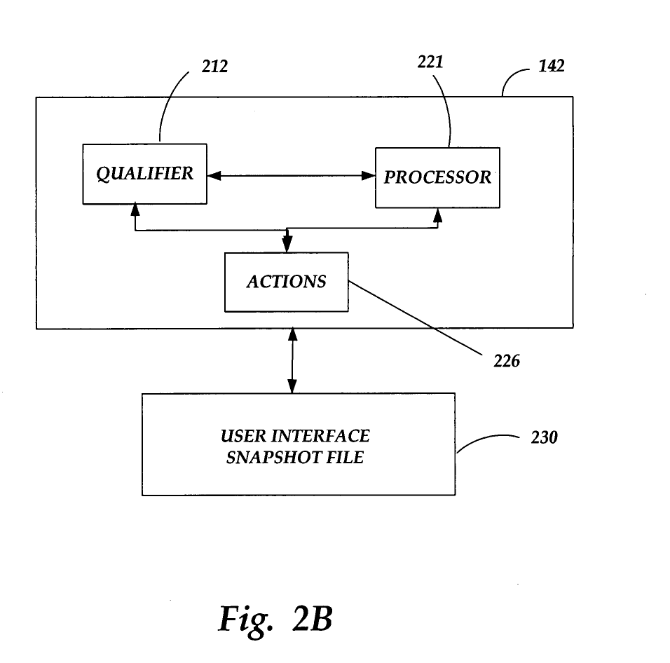

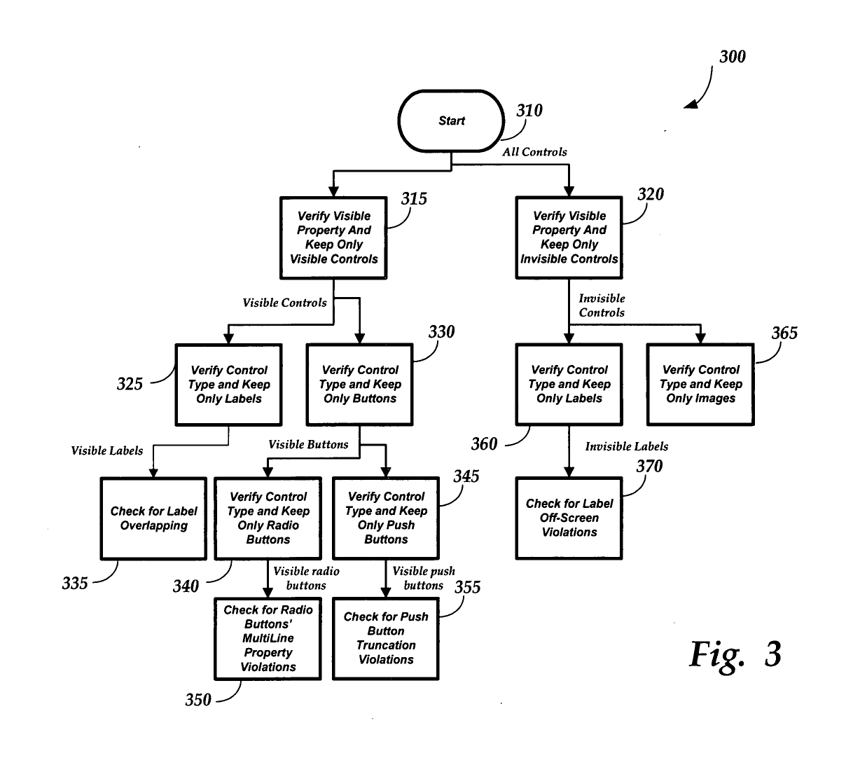

FIG. 2A illustrates a system architecture and operation of a design rule processor that processes user interface design rules interpreted from design guidelines. At operation 202, the Rule Processor 146 loads a snapshot instance 126 prior to checking any rules. The snapshot instance may be in XML format and may contain all the user interface runtime elements that an applicable rule set requires. At operation 205, the next rule to run against the snapshot is located by the Rule Processor 146. The rules can be run sequentially or in parallel which will be described in more detail below with reference to FIG. 3.

Referring to FIG. 2B, according to an embodiment, a configured rule may consist of a qualifier set 212 and one or more processors 221 and actions 226. Qualifiers define in what situations a given rule should or should not apply to a UI component. Qualifiers may include preconditions and exceptions. Preconditions describe the situations in which a rule is required, and exceptions describe situations in which a rule does not apply. For example, a qualifier may stipulate that the presence of a selectable button in a UI requires application of a rule governing button size, and an associated precondition may describe that the rule must be applied when a given button is located in a toolbar of buttons, while an exception may be invoked for a free-standing button where button size is not important. Accordingly, if a given UI or UI component is qualified against a particular rule, the rule may be matched (rule required) against a precondition of the rule or may be unmatched (rule not required) against the precondition, or the rule may not be applied because the subject UI or UI component is an exception to the precondition. The preconditions and exceptions may be a subset of a finite set of UI component properties analyzed by the UI inspection system 100. According to an embodiment, each rule may have at most one precondition and exception set. However, multiple instances within a set are allowed and there is no upper limit.

Referring back to FIG. 2A, at operation 210, any preconditions and exceptions are applied to the controls hierarchy (see FIG. 3) of the snapshot instance 126 being analyzed. At operation 220, the Rule Processor 146 defines what to check in the given UI snapshot instance when the rule is applied to the snapshot because the snapshot contains control(s) that match(es) an associated qualifier 212. If a control in the snapshot matches the preconditions and is not in the exception list, the control in the UI snapshot is then analyzed by the processors 221 and an output is produced. The output of a processor is always true or false and identifies whether the control in the UI snapshot violates the rule, for example, where the UI snapshot is processed against an overlapping control rule, and an overlapping control is found in the output of that rule.

According to embodiments, a number of different rule plug-ins 222 are available for defining what properties of a given UI to check when a given rule is applied to a given UI. One rule plug-in 222 includes the Property Check (PRC) processor. This processor may verify the values of one or more UI or UI component properties. The logical relation between the properties can be AND, OR, NOT (only one property will be considered if NOT is selected). Properties that may be checked include, but are not limited to, ClassName, ControlName, ProcessName, Text, ControlID, Left position, Top position, Width, Height, ChildrenCount, Visible, Enabled, Focused, InForeground, IsChild, IsForeground, IsTopLevel, IsMultiLine, and the like. Character count of controls may also be checked. For example, normally only selected text is seen in a UI combo box. This processor provides a count for all characters in all the items in the combo box.

Another rule plug-in 222 includes the Internal Space Check (ISC) processor. Internal space refers to the space within a UI control where text can be drawn, but that is left blank. This processor measures (distance in number of pixels) the internal free space of a given control. This measurement becomes meaningful when the control contains text. If the control does not contain text, then the internal space outputs zero. For internal space checks, a minimum space may be set both horizontally and vertically for a given control. The ISC process can report violation once the minimum space is not met.

Another rule plug-in 222 includes the External Space Check (ESC) processor. External space refers to the distance that a control can move without intersecting other controls. This processor measures (in number of pixels) the external free space of a control. The measurement can be relative to all other controls within the same parent in the control hierarchy or it may be relative to absolute values from the edge of the screen. Unlike internal space check, a minimum space may be selected on the left, right, top and bottom instead of just two directions. The ESC process can report violation once the minimum space is not met.

Another rule plug-in 222 includes the Truncation Check (TRC) processor. Truncation refers to text that is not visible due to insufficient display space in the container control. This processor checks whether text within a control is truncated or not. It can be applied to controls that have text and a limited set of text container controls, such as combo boxes, list boxes, list views and menus.

Another rule plug-in 222 includes the Overlap Check (OLC) processor. Overlap refers to the situation when a border of a UI control intersects a border of another control. According to an embodiment, this processor checks whether two controls with a same parent control in the control hierarchy are overlapped or not. As should be appreciated, some controls are intended to be overlapped with other controls, such as menu and notify dialogs. This processor will report those violations, but those violations may be made precondition exceptions to prevent them from being reported as defects.

Another rule plug-in 222 includes the Off-Screen Check (OSC) processor. Off-screen refers to the situation in which part of all of a given control is outside the boundary of the UI or UI component in which it is situated. The boundary may be configured to be the boundary of a parent control, the screen or both. This processor may report violation if the control goes out of bound.

Another rule plug-in 222 includes the Text Abbreviation Followed By Enough Space (Design Pattern 1 (DP1)) processor. This processor reports situations where the text within a control is abbreviated, but where enough external horizontal space is found to accommodate making the control large enough to contain an unabbreviated text string. An abbreviation may be defined by specifying the suffix as well as the maximum external horizontal free space.

Another rule plug-in 222 includes the Labels Closely Followed by Other Control (Design Pattern 2 (DP2)) processor. This processor points out the situations in which labels are lined up with other controls, which is not considered a good pattern for a display device with limited screen space.

Another rule plug-in 222 includes the Control Closely Between Two Labels (Design Pattern 3 (DP3)) processor. Control-between-two-labels designs are not considered to be good for UI design localization because localization engineers/designers often need to move controls that are located between labels, and where the space between two labels is insufficient, movement may be restricted. The distance between the centers of the controls in a layout may be defined both horizontally and vertically.

Still another rule plug-in 222 includes the Undo (UDO) processor. A history of rules applications is maintained and the UDO processor may be invoked to revert a rule application state to a previous state. According to an embodiment a restore point must be defined for a rule so that the state may be reverted a subsequent point in time. As should be appreciated, the rule processors listed and described above are for purposes of example and are not exhaustive of all the various rule processors that may be utilized in accordance with embodiments of the present invention for determining whether a particular component of a UI snapshot matches an associated rule qualifier.

Referring still to FIG. 2A, the Rule Processor 146, at operation 220, may generate a report on the violations found during the rule analysis, and, at operation 224, depending on whether violations are found, the Rule Processor 146 may either export the violation report with computed score based on the weight of the rule and the number of violations (operation 230), or determine whether additional rules are available to apply to the analyzed UI snapshot instance (operation 240). Furthermore, a result from this rule analysis also may affect the candidates for the next rule analyses (operation 226). For example, if the current rule is configured to check the visible property of controls in a snapshot and filter out all the invisible controls, all the invisible controls will be marked after this rule and will not be considered on all sequential rules. At operation, controls that are excluded in the next rule analysis are filtered out based on the rule output. This process continues until no more snapshots need to be processed (operation 255).

Referring to FIG. 3, the rules 142 in the UI inspection system 100 may comprise a tree system 300 where the rule execution sequence can be sequential or in parallel. The root of the tree is where the rule analysis starts and the leaves of the tree are where the rule analysis ends for a given branch. From the root to the leaves of the rule tree, many different rule paths may be formed. According to an embodiment, all rules in an individual rule path are processed one by one, and the output of a given rule analysis becomes the input of a next rule in the path. Combining two rule trees may be done by connecting one rule in one rule tree to the root of another rule tree. This enables the building of new rules on top of existing rules. Using the rules 140, the UI inspection system 100 may provide a more complicated rule tree that may be constructed based on the analysis requirements of a given user interface.

Referring still to FIG. 3, the rule tree 300, for example, illustrates how a customized rule set representing a set of design guidelines may be formed using a rule tree. For purposes of illustration, each block in the rule tree 300 represents a design rule. For example, block 315 represents a rule that filters out invisible items so any subsequent rules will only apply to visible controls. Block 325 represents a rule that filters out other-than-label controls so the subsequent rules will operate only on visible label controls. Block 335 represents a rule that checks for overlapping control violations.

The rule tree 300 may be created such that all user interface rules scenarios may be defined in terms of the hierarchical relationships between user interface components according to a given software application user interface. For example, a first example rules scenario for a given user interface may include “avoid overlapping for visible labels.”. To achieve this example rule check, a rule path is formed from block 310 to block 315 to block 325 and to block 335 where this path checks for the “visible” property, “control type” property, and “overlapping” violation. According to an embodiment, the reason why the rule tree is configured in this way instead of combining some of the analysis together is that other rules in this rule set may be checking for similar UI attributes and associated violations. For example, a second rule scenario may include a determination as to whether all visible radio buttons have multiLine property enabled. To achieve this rule analysis, a rule path is formed from block 310 to block 315 to block 340 and to block 350. Thus, this rule scenario shares some of the same path with the first rule scenario, including the “visible” property analysis 315. According to an embodiment, for better performance and reduction of redundant rule analysis, the verification of the “visible” property (according to this example) is done only once, and the result will be forwarded to both rule nodes in the paths.

According to an embodiment, in order to ensure the overall user interface of a given software application is not defective, a rule tree may be created for verifying defective design. As illustrated in FIG. 3, such a rules tree may include rules that check control overlaps, off-screens, truncations, etc. As should be appreciated from the foregoing, a rule tree may be created for any number of user interfaces, including different combinations of user interface components, for example, a rule tree for a dialog box that may be displayed in a user interface. In addition a single rule tree may be generated to combine all rule trees associated with various UI component rule trees associated with an overall software application user interface and such generate a very complicated rule analysis system.

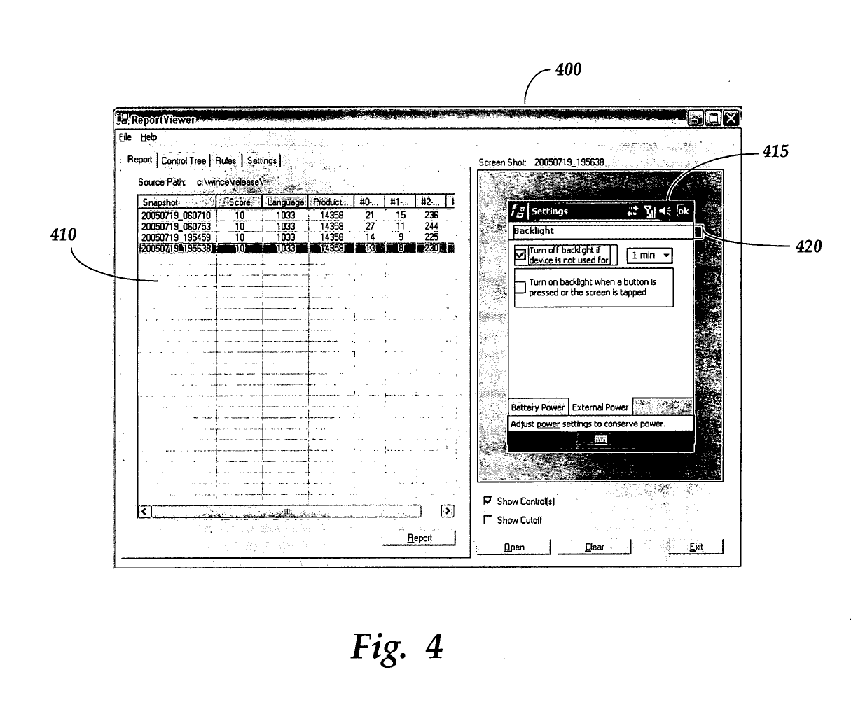

Referring now to FIG. 4, a report viewer user interface 400 is illustrated for providing scoring information about one or more user interface snapshots that have been inspected by the user interface inspection system 100 according to a set of rules 140 configured by the Rule Configurator 135 from a set of Design Guidelines 130, as described above with reference to FIG. 1. The report viewer 400, illustrated in FIG. 4, shows a UI inspection report for a given user interface and shows a listing of UI snapshots analyzed for the user interface along with individual snapshot scores, language identifiers, product identifiers and an enumeration of errors or defects found in the associated user interface snapshots. As illustrated in FIG. 4, the window 410 is populated with data for each user interface snapshot analyzed for a given software application. According to one embodiment, when the “Report” tab is selected, the user interface inspection system 100 searches the path of a selected UI snapshot to find the associated XML file and user interface snapshot. Along the right side of the report viewer 400 is a view pane in which is displayed a view of a particular user interface snapshot selected from the window 410. As illustrated in FIG. 4, the user interface snapshot 415 illustrated on the right side of the report viewer 400 shows a text box border that has violated an off-screen rule where the text box border 420 is displayed off screen relative to the snapshot user interface 415.

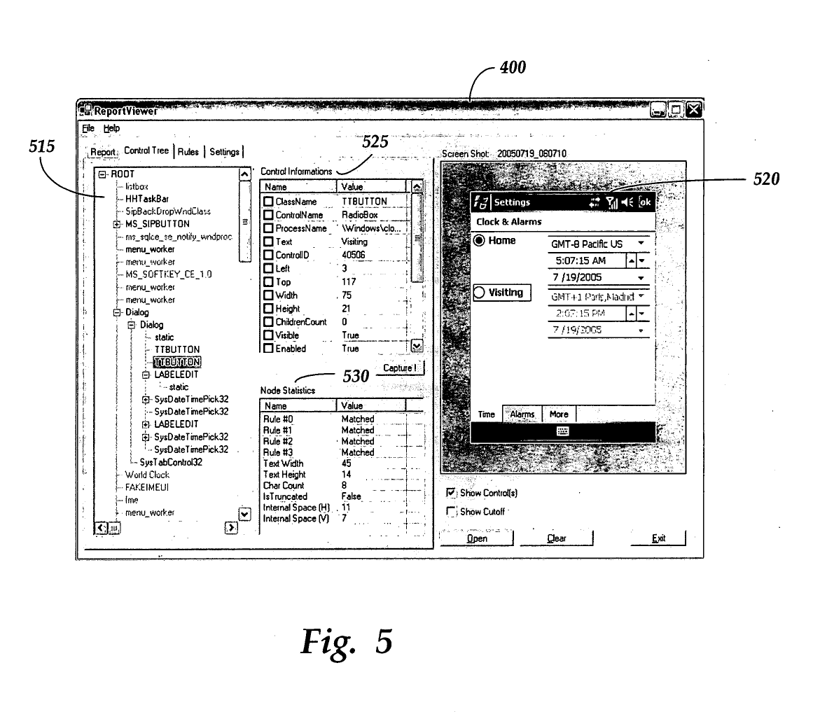

Referring now to FIG. 5, the user interface 400 of FIG. 4 is illustrated after selection of the “Control Tree” tab. According to an embodiment, each XML file records one control hierarchy for a given user interface snapshot. The control tree viewer, illustrated in FIG. 5, visually represents the hierarchy of rules associated with a given user interface snapshot inside the window 515. According to an embodiment, invisible controls may be shown in a “grayed-out” manner or any other method for distinguishing invisible controls from visible controls. According to another embodiment, when a different rule output is selected on the report viewer, illustrated in FIG. 4, the control tree viewer may be dynamically revised by deleting all filtered controls from the view. In the Control Information list 525, all properties associated with a selected control from the window 515 are displayed and may be captured as the qualifiers for the Rule Configurator 135. The Nodes Statistic list 530 shows any match/mismatch status for all rules as well as the character count, text width, etc. for a selected control. As described above with reference to FIG. 4, a screen shot 520 associated with the selected control is illustrated on the right side of the Control Tree viewer, illustrated in FIG. 5.

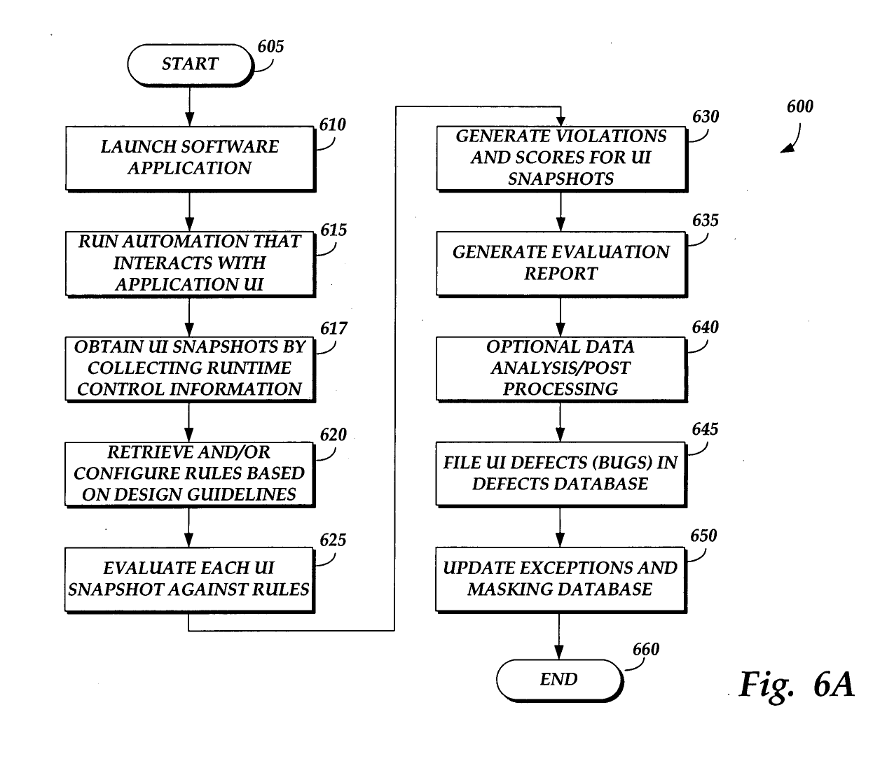

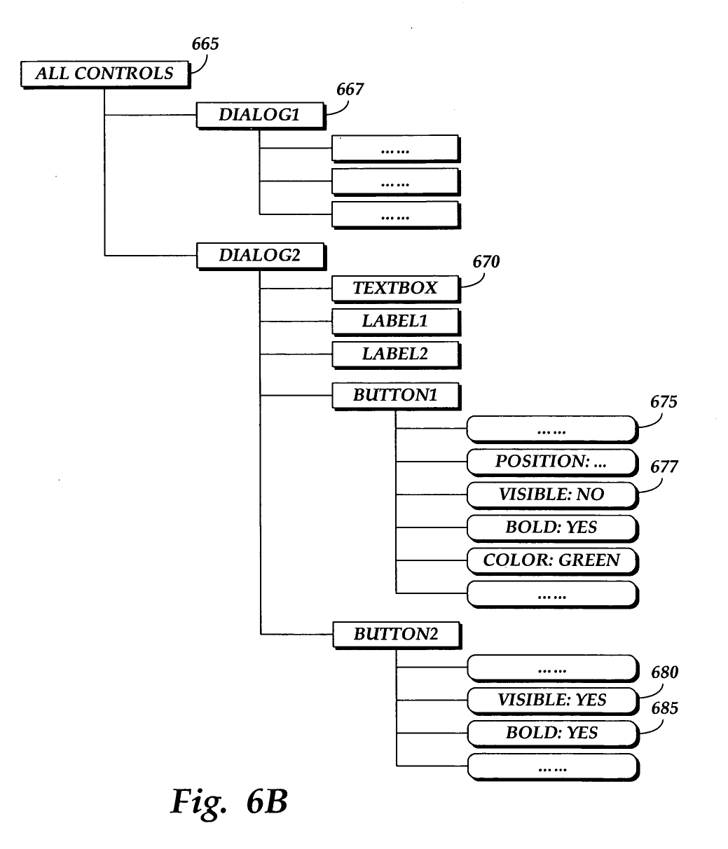

Having described a system architecture for and attributes of the user interface inspection system 100 with respect to FIGS. 1 through 5 above, it is advantageous to describe operation of the user interface inspection system 100 with respect to an example analysis of the user interface of a given software application. FIG. 6 is a logical flow diagram illustrating a method of inspecting a software application user interface. For purposes of discussion of FIG. 6, consider that an example user interface of an example word processing application or any other software application having one or more user interfaces is examined against a set of design guidelines 130 developed for the user interfaces of the example software application for dictating the proper display and layout of user interface components for the user interface.

Referring to FIG. 6, the method begins at start operation 605 and proceeds to operation 610 where a software application containing the user interface(s) to be analyzed is launched for operation. At operation 615, the application's targeted UI are visited by either manual navigation or automation using the UI inspection system 100. At operation 617, the user interface inspection system 100 collects runtime control information for the launched software application. As described above, the runtime control information includes identification of each control contained in the user interfaces of the analyzed software application including any hierarchal relationships between respective controls. The runtime control information will be used to compare with the design guidelines information for each user interface control obtained in the next operation. User interface snapshot files are generated and obtained for each permutation of the user interfaces that may be displayed for the analyzed software application. As described above, the user interface snapshots generated and obtained by the user interface inspection system 100 may be formatted according to the Extensible Markup Language.

At operation 620, the user interface inspection system 100 retrieves the design guidelines 130 and passes the design guidelines 130 to the Rule Configurator 136. As described above with reference to FIG. 1, the Rule Configurator 136 configures and stores the rules 142 for use by the user interface inspection system 100 in analyzing one or more user interface snapshots generated for the user interfaces of the launched software application.

At operation 625, the user interface inspection system 100 evaluates each user interface snapshot against the rules configured and stored by the user interface inspection system 100 at operation 620. According to an embodiment, each snapshot for each potential user interface of the launched application may be analyzed automatically by the Rule Processor 146 (FIG. 2). In this operation, the rule analysis is performed on all snapshots against all loaded rules.

At operation 630, violation data may be generated and a score for each snapshot may be calculated based on the weight of the rule that is violated and the number of violations. At operation 635, an evaluation report is generated which includes the violations, score, and other system environment variables when the snapshot was captured. At operation 640, optional data analysis or post processing may be performed against the data generated for the evaluation report 150. For example, a data analysis algorithm may be run against information contained in the evaluation report 151 for generating additional reporting information for defects found in individual user interface snapshots. For another example, optional data analysis or post processing may include the generation of warnings that may be presented to a developer or user of the user interface inspection system that defects or bugs have been found in a given user interface snapshot. As should be appreciated, during the optional data analysis/post processing operation 640, any number of uses of the reported evaluation data may be made as desired by a user of the inspection system 100.

At operation 645, any user interface defects (violations) detected by the Rule Processor 146 in various user interface snapshots may be maintained in database 156 for subsequent use by a user or developer of the analyzed software application. At operation 645, defects (bugs) may be filed based on the violations described in the report. Other related information such as system runtime statistics may also be included in the defect description. At operation 650, if a particular violation is identified as an exception, it may be stored under an exception for the rule. For example, if a label is identified as an off-screen rule violation, but the off-screen violation is design for some reason, it can be an exception of the off-screen rule. During the next rule analysis, the rule process will not check this label for the off-screen rule since this label will be put under the exception list of the off-screen rule. The method ends at operation 660.

FIG. 6B is a simplified block diagram illustrating how a user interface snapshot instance is checked against a design rule, as described above with reference to FIG. 6A. Block 665 “All Controls” represents that a control tree analysis traversal starts from the top and proceeds recursively. Block 667 illustrates an embodiment wherein user interface controls may have multiple children controls. Referring to Block 670, the type associated with this example control is “Textbox.” According to the example illustrated in FIG. 6B, because this control does not match a “button” type of control associated with the parent “Dialog2,” it will be ignored by the rule. Referring to Block 675, each control has a number of properties with a set of possible values. An associated rule may filter by any of the available properties and possible values. Block 677 represents an example wherein a control type is a match for a given control, for example, “button,” but the “visible” property is false, and therefore, the rule does not apply. Block 680 represents an example wherein an analyzed control matches a given control type, for example, “button” control type, and where the “visible” rule applies. Block 685 represents an example where the analyzed control matches a given control type, for example, “button” and where the “visible” rule applies, but where the “bold” attribute is “yes” which means the rule is violated, and therefore, a score for the analysis of this rule against the given user interface is decreased. As should be appreciated, the foregoing discussion of FIG. 6B is for purposes of example only and is not exhaustive of the many ways in which a user interface snapshot instance may be checked against a design rule.

As described herein with respect to FIG. 6, the various permutations of user interface components contained in different views of the user interfaces of an analyzed software application are analyzed against design guidelines developed for the user interfaces of the analyzed software application when the application is run. Thus, the design guidelines which are configured into a set of user interface rules are run against user interfaces of the analyzed software application as those user interfaces appear to a user of the analyzed software application at application runtime.

As described above with reference to FIGS. 1 through 6, the user interface inspection system 100 analyzes each permutation of the user interfaces of a given software application against a set of user interface design guidelines by converting the design guidelines into a set of rules using a Rules Configurator. The user interface inspection system 100 analyzes each user interface snapshot file against the design rules to determine whether user interface components in each user interface snapshot are properly displayed, located, shaded, identified, etc. as required by the design rules. As should be appreciated, during runtime of a given software application, each potential permutation of displayable user interfaces for the launched software application may not receive a corresponding user interface snapshot that may be analyzed by the user interface inspection system 100 against the rules 140 configured for the analyzed software application user interface. That is, depending on the runtime operations of the analyzed software application, some user interface permutations (different combinations of user interface components displayed on the user interface of the analyzed software application) may not be generated by the user interface inspection system 100 for analysis against the configured rules 140.

Referring now to FIG. 7, a routine 700 that may be performed by a user interface coverage system 707 using the same toolset as the user interface inspection system 100 for automatically determining the amount of available user interfaces for a given software application and for determining all possible user interface snapshots is illustrated. According to this embodiment, user interface control coverage automation compares the user interface snapshot files for combinations of user interface controls with the set of user interface controls extracted from the software application that may be displayed during operation of the user interface. The routine 700 begins at start operation 705 and proceeds to operation 710 where user interface resources information is collected/extracted from the software application and is stored in a database. This is a preparation stage where the UI coverage process, described herein with reference to FIG. 7, generates a “baseline” of all available user interface elements/controls which may be used later in the inspection process, described above.

At operation 710, the user interface coverage system 707 statically collects user interface information from the software application without launching it, including information identifying all available user interface controls and relationships between available user interface controls, as illustrated above in FIG. 3. At operation 715, the user interface coverage system 707 launches the software application for which the UI coverage is to be determined. Then at operation 720, automation is run that interacts with the UI of the launched application. At operation 725 the user interface coverage system 707 generates user interface snapshot files by collecting runtime information for user interface components. As described above, the user interface snapshots for each individual user interface control may be formatted according to a standard format such as the Extensible Markup Language format.

At operation 715, the software application is launched so the runtime information for it can be collected. At operation 720, the user interface coverage system 707 uses (test) automation or manual user actions to interact with the user interface. This interaction may be targeted to automatically to crawl or parse the user interfaces of the launched application to “walk through” and display as many as possible user interface component combinations available through the launched application. For example, a basic user interface of a word processing application may include a text entry area and a row of functionality buttons or controls along an edge of the text entry area. If automated user interface testing is utilized for automated parsing or crawling of the user interface, the automated user interface testing will virtually launch and parse each user interface combination available (in the testing code) to the launched software application. For example, all available dropdown menus, dialog boxes, or any other available displayable user interface components are parsed by the user interface coverage system 707. At operation 725 snapshots for the user interface controls are generated in the same way as described above for the user interface inspection system 100.

At operation 730, the user interface coverage system 707 compares the user interface controls displayed in the various user interface component combinations against the user interface controls baseline generated at operation 710. At operation 730, the user interface inspection coverage system 707 determines which, if any, user interface controls are not engaged during the automated user interface coverage process. That is, at operation 730, the user interface coverage system 707 determines whether any user interface controls available to the software application for inclusion in a given user interface component combination is not seen by the user interface coverage system 707 during the user interface parsing (manual or by automation). At operation 735, the user interface coverage system 707 generates a report of the user interface controls of the launched software application covered by the automated user interface parsing process. As a result of the report of user interface controls covered (or not covered) during the automated user interface parsing process, the user interface coverage system 707 provides information on those user interface controls for which user interface snapshots 125 will not (and cannot) be generated for analysis against the rules 140 during the runtime analysis of a launched software application user interface, as described above with reference to FIG. 6. In other words the user interface coverage system 707 provides information as to which parts of the user interface for an application can and which parts cannot be evaluated using the user interface inspection system 100.

When it is determined that one or more user interface controls available to the user interfaces of a launched application will not be analyzed against the rules 142 during the runtime analysis performed by the user interface inspection system 100, then this information can be used to adjust the test automation to interact with the UI of a given application. Once this is done and test automation is extended to interact with “not covered” user interface components, on a consecutive (next) run, the user interface inspection system 100 may generate user interface snapshot files 125 for any user interface controls not engaged during the automated user interface parsing process, described in FIG. 7, for analysis against rules 140 for defects (bugs) when the associated controls are displayed in a user interface of the launched application. According to one embodiment, the automated UI parsing process, illustrated in FIG. 7, may be run automatically as part of the UI inspection and analysis process, illustrated in FIG. 6. Alternatively, the automated UI parsing process, illustrated in FIG. 7, may be run as a standalone process for determining all potential user interface component combinations for a selected software application.

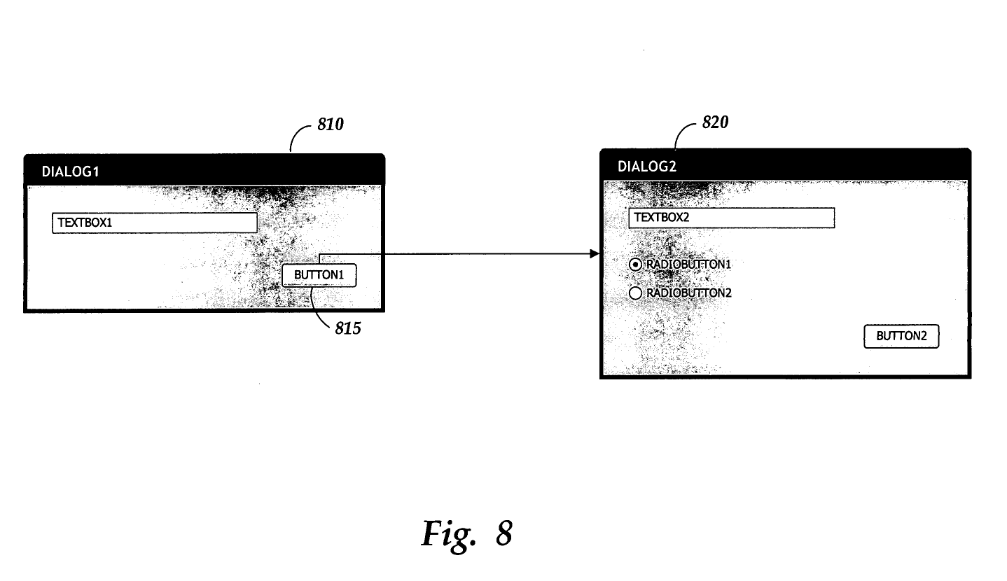

FIGS. 8, 9 and 10 illustrate computer screen displays of example user interface components for which a user interface coverage system may be used for ensuring inspection of available user interface components. Referring to FIG. 8, an example software application user interface has two dialogs. The first dialog 810 includes a textbox and a button 815. When the button 815 is selected, the second dialog box 820 is displayed. The second dialog 820 has a textbox and two radio buttons. The user interface coverage system 707, at operation 710, collects static user interface information from the application and extracts all information about the components of the dialog boxes 810, 820 and stores the information, as described above. Consider, for example, that application of the user interface coverage system 707 results in a determination that both dialog boxes are not seen during processing by the user interface coverage system at operation 715, then coverage for the two dialogs would be zero (0%) percent.

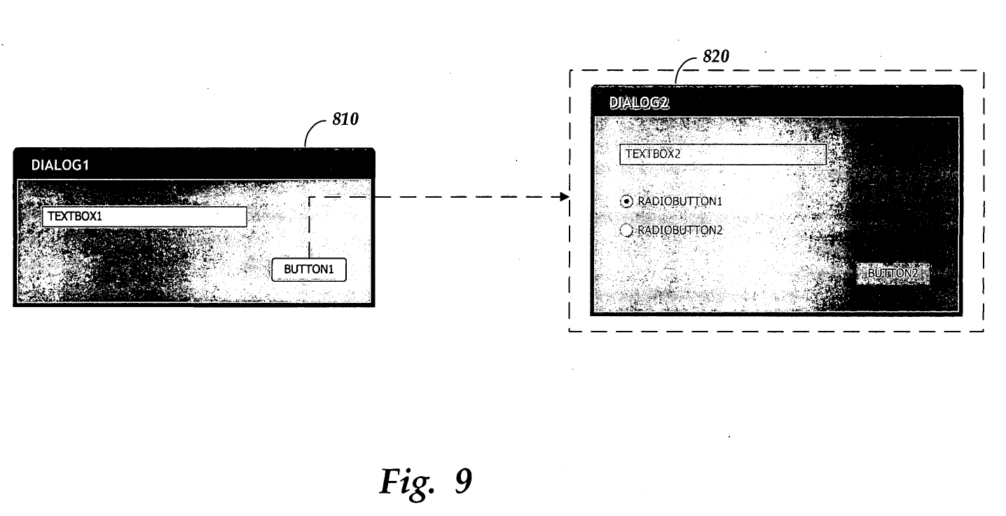

Referring to FIG. 9, the application is launched and interaction is performed with the user interface of the software application, and the UI coverage system 707 opens dialog 810. Coverage for the user interface is returned at 100% because the first dialog box is opened and the second dialog box is not encountered because the button 815 has not been selected. The second dialog box 820 is not detected because there is no run time information for the second dialog box 820. At operation 730, the user interface coverage system 707 compares the static user interface information with the run time information and determines the user interface coverage. The user interface coverage system 707 may then generate a report which will contain information that the coverage for the dialogs is only 50% because only one out of two dialogs was detected, and that the coverage for the first dialog box is 100% while coverage for the second dialog box is 0%.

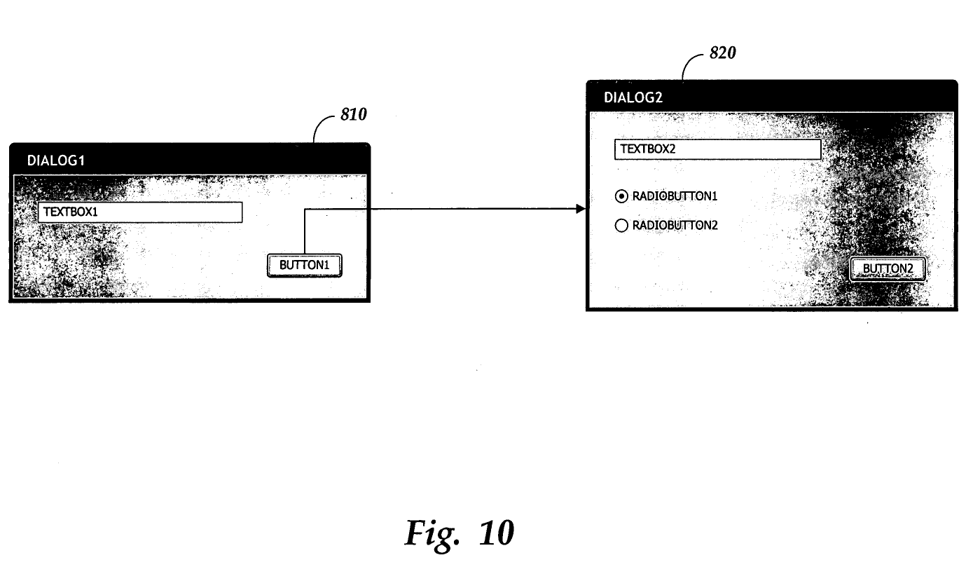

Referring then to FIG. 10, on a subsequent running of the user interface inspection system 707, a second test automation script may be executed wherein the first dialog box 810 is opened and the button 815 is selected which will launch the second dialog and a subsequent UI snapshot will be generated. When the static and runtime information is compared in this case, the UI coverage system 707 for the application will be 100% for the first dialog box and 100% for the second dialog box. Then information for UI coverage for the displays illustrated in FIGS. 9 and 10 may be used by the user interface inspection system 100 for evaluating all possible user interface displays for the example software application.

### Operating Environment

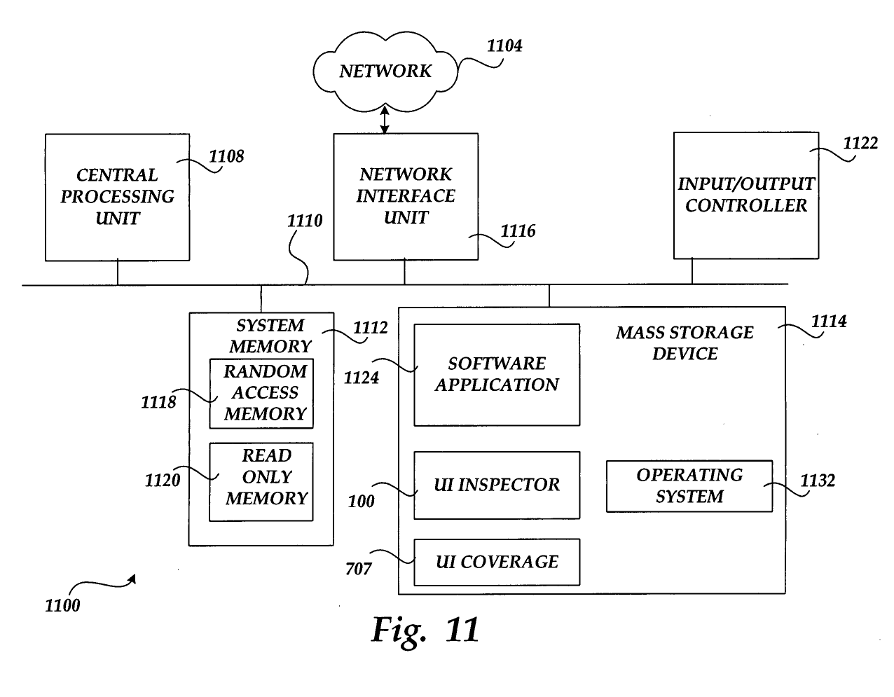

Referring now to FIG. 11, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 11, an illustrative operating environment for embodiments of the invention will be described. As shown in FIG. 11, computer 1100 comprises a general purpose desktop, laptop, handheld, or other type of computer capable of executing one or more application programs. The computer 1100 includes at least one central processing unit 11 (“CPU”), a system memory 1112, including a random access memory 1118 (“RAM”) and a read-only memory (“ROM”) 1120, and a system bus 1110 that couples the memory to the CPU 1108. A basic input/output system containing the basic routines that help to transfer information between elements within the computer, such as during startup, is stored in the ROM 1120. The computer 1102 further includes a mass storage device 1114 for storing an operating system 1132, application programs, and other program modules.

The mass storage device 1114 is connected to the CPU 1108 through a mass storage controller (not shown) connected to the bus 1110. The mass storage device 1114 and its associated computer-readable media provide non-volatile storage for the computer 1100. Although the description of computer-readable media contained herein refers to a mass storage device, such as a hard disk or CD-ROM drive, it should be appreciated by those skilled in the art that computer-readable media can be any available media that can be accessed or utilized by the computer 1100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 1100.

According to various embodiments of the invention, the computer 1100 may operate in a networked environment using logical connections to remote computers through a network 1104, such as a local network, the Internet, etc. for example. The computer 1102 may connect to the network 1104 through a network interface unit 1116 connected to the bus 1110. It should be appreciated that the network interface unit 1116 may also be utilized to connect to other types of networks and remote computing systems. The computer 1100 may also include an input/output controller 1122 for receiving and processing input from a number of other devices, including a keyboard, mouse, etc. (not shown). Similarly, an input/output controller 1122 may provide output to a display screen, a printer, or other type of output device.

As mentioned briefly above, a number of program modules and data files may be stored in the mass storage device 1114 and RAM 1118 of the computer 1100, including an operating system 1132 suitable for controlling the operation of a networked personal computer, such as the WINDOWS® operating systems from MICROSOFT CORPORATION of Redmond, Wash. The mass storage device 1114 and RAM 1118 may also store one or more program modules. In particular, the mass storage device 1114 and the RAM 1118 may store application programs, such as a software application 1124, for example, a word processing application, a spreadsheet application, etc. According to embodiments of the present invention, a user interface inspection system application 100 is illustrated for performing the user interface inspection described herein. As should be appreciated, the user interface inspection system may operate as a standalone application that may be called by a given software application at application runtime, or the UI inspection system 100 may be an application module integrated with another software application 1124, for example, a word processing application. Similarly, a user interface control coverage automation module 707 is illustrated for performing the UI component coverage process described above with reference to FIG. 7. The UI coverage module 707 may likewise operate as a standalone software application, or it may be integrated with the UI inspection system 100 or with another software application 1124, for example, a word processing application.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

We claim:

1. A method of runtime verification of a software application user interface, comprising:
launching a software application having a user interface, the software application user interface having one or more user interface components;
retrieving one or more user interface design guidelines for the software application user interface;
configuring one or more user interface design rules from the one or more user interface design guidelines for verifying compliance of the user interface with the one or more user interface design guidelines;
generating a user interface snapshot file representing the user interface;
analyzing the user interface snapshot file against the one or more design rules that are applicable to any user interface components of the user interface snapshot file; and
generating violation report for the user interface snapshot file based on compliance with any of the one or more design rules applied to the user interface snapshot file.

2. The method of claim 1, prior to configuring one or more user interface design rules, further comprising passing the one or more user interface guidelines to a user interface rule configurator, and at the rule configurator, generating the one or more user interface design rules in a format that may be applied to the user interface snapshot file.

3. The method of claim 2,
wherein generating a user interface snapshot file representing the user interface, includes generating an Extensible Markup Language (XML) file representing the components and a design configuration of the components of the user interface; and
wherein generating the one or more user interface design rules in a format that may be applied to the user interface snapshot file includes generating the one or more user interface design rules in an XML format that may be applied to an XML-formatted user interface snapshot file.

4. The method of claim 1, wherein configuring one or more user interface design rules includes assigning a scoring weight to each of the one or more design rules.

5. The method of claim 4, wherein assigning a scoring weight to each of the one or more user interface design rules includes assigning a scoring weight to each of the one or more user interface design rules based on an importance of each of the one or more user interface design rules to a desired user interface display attribute.

6. The method of claim 1, wherein generating a violation report for the user interface snapshot file includes identifying any user interface components of the user interface snapshot file that violate any of the one or more design rules; and determining a number of violations of each of the one or more user interface design rules occurring in the user interface snapshot file.

7. The method of claim 6, further comprising displaying the violation report for the user interface snapshot file in a report viewer user interface.

8. The method of claim 7, further comprising displaying a visual representation of the user interface snapshot file in the report viewer user interface, the visual representation showing the locations of any violations of any of the one or more design rules occurring in the user interface snapshot file.

9. The method of claim 1, further comprising storing data representing any violations of any of the one or more user interface design rules occurring in the user interface snapshot file in a user interface defects database.

10. The method of claim 1, further comprising
retrieving and enumerating static user interface components information from the software application;
during software application runtime, identifying each user interface control available for display in the user interface;
generating a runtime user interface information in a form of a snapshot file for each user interface control in the user interface at software application runtime;
identifying and matching the runtime user interface components information from the snapshot files and matching it to a corresponding static user interface components information from the software application;
calculating and evaluating a user interface coverage ratio by comparing the runtime user interface components information snapshot files content to the static user interface components information retrieved from the application without executing the software application.
parsing the user interface of software application and generating user interface snapshots for any visible screens/forms/dialogs of the user interface;
running a user interface control automation against the user interface for generating snapshot files for each combination of user interface controls that may be displayed during operation of the user interface; and
determining any of the identified user interface controls that are not displayed in any of the user interface snapshot files generated for each combination of user interface controls that may be displayed during operation of the user interface.

11. The method of claim 10, wherein running the user interface control automation includes parsing the user interface snapshot files for each combination of user interface controls that may be displayed during operation of the user interface, and determining whether any identified user interface control available in the software application for display in the user interface is present or not present in any of the user interface snapshot files for each combination of user interface controls that may be displayed during operation of the user interface.

12. The method of claim 11, further comprising generating a report of any identified user interface control available for display in the user interface that is not present in any of the user interface snapshot files for each combination of user interface controls that may be displayed during operation of the user interface.

13. The method of claim 10, further comprising wherein the user interface coverage ratio is used to determine a level of user interface exposure and testing progress during user interface development and verification.

14. The method of claim 10, further comprising, ensuring that any identified user interface control available for display in the user interface that is not present in any of the user interface snapshot files for each combination of user interface controls that may be displayed during operation of the user interface is analyzed against the one or more design rules that are applicable to any user interface components of the user interface snapshot file.

15. A computer readable medium containing computer executable instructions which when executed by a computer perform a method of runtime user interface component analysis coverage, comprising:
launching a software application having a user interface, the software application user interface having one or more user interface controls;
during software application runtime, identifying each user interface control available for display in the user interface;
generating a user interface snapshot file for each identified user interface control available for display in the user interface;
generating a user interface snapshot file for each combination of user interface controls that may be displayed during operation of the user interface;
running a user interface control coverage automation against the user interface snapshot files for each combination of user interface controls that may be displayed during operation of the user interface; and
determining any of the identified user interface controls that are not displayed in any of the user interface snapshot files generated for each combination of user interface controls that may be displayed during operation of the user interface.

16. The method of claim 15, wherein running the user interface control coverage automation includes parsing the user interface snapshot files for each combination of user interface controls that may be displayed during operation of the user interface, and determining whether any identified user interface control available for display in the user interface is not present in any of the user interface snapshot files for each combination of user interface controls that may be displayed during operation of the user interface.

17. The method of claim 16, further comprising generating a report of any identified user interface control available for display in the user interface that is not present in any of the user interface snapshot files for each combination of user interface controls that may be displayed during operation of the user interface.

18. The method of claim 15, further comprising,
ensuring that any identified user interface control available for display in the user interface that is not present in any of the user interface snapshot files for each combination of user interface controls that may be displayed during operation of the user interface is analyzed against one or more design rules applicable to the user interface; and
determining whether the any identified user interface control available for display in the user interface that is not present in any of the user interface snapshot files for each combination of user interface controls that may be displayed during operation of the user interface complies with the one or more design guidelines against which it is analyzed.

19. A user interface inspection system for runtime verification of a software application user interface, comprising:
a control enumerator operative to generate a user interface snapshot file representing the user interface during software application runtime, the user interface snapshot file including data representing one or more user interface controls comprising the user interface and including data representing a display configuration of the one or more user interface controls comprising the user interface;
a rule configurator operative
to retrieve one or more user interface design guidelines for a launched software application user interface;
to configure one or more user interface design rules from the one or more user interface design guidelines for verifying compliance of the user interface with the one or more user interface design guidelines;
the control enumerator being further operative to analyze the user interface snapshot file against the one or more design rules that are applicable to any user interface components of the user interface snapshot file; and
a report generator operative to generate a score for the user interface snapshot file based on compliance with any of the one or more design rules applied to the user interface snapshot file.

20. The system of claim 19, further comprising
a user interface control coverage automation module operative
to identifying each user interface control available for display in the user interface during software application runtime;
to generate a user interface snapshot file for each identified user interface control available for display in the user interface;
to generate a user interface snapshot file for each combination of user interface controls that may be displayed during operation of the user interface;
to run a user interface control coverage automation against the user interface snapshot files for each combination of user interface controls that may be displayed during operation of the user interface; and
to determine any of the identified user interface controls that are not displayed in any of the user interface snapshot files generated for each combination of user interface controls that may be displayed during operation of the user interface.
